(19) United States
(12) Patent Application Publication
(10) Pub. No.: US 2026/0039758 A1
(43) Pub. Date: Feb. 5, 2026

(54) METHODS AND SYSTEMS FOR GUIDING VOTER VISUAL BALLOT CHECKING INTERACTIONS

(71) Applicant: William Marsh Rice University

(72) Inventors: Philip Kortum, Houston, TX (US); Michael Byrne, Houston, TX (US); Fred Oswald, Houston, TX (US); Fabrizio Chavez, Houston, TX (US)

(73) Assignee: William Marsh Rice University, (omitted)

(21) Appl. No.: 19/285,659

(22) Filed: Jul. 30, 2025

Related U.S. Application Data
(60) Provisional application No. 63/677,637, filed on Jul. 31, 2024.

(51) Int. Cl. H04N 1/00; G06F 3/01; G07C 13/02

(52) U.S. Cl. CPC H04N 1/00774; G06F 3/013; G07C 13/02; H04N 1/00724

(57) ABSTRACT

A method for enhancing visual inspection of a completed voting ballot includes receiving, by a central processing unit (CPU), the completed voting ballot, where the completed voting ballot includes one or more races, and where the completed voting ballot is an unsubmitted ballot that has not been finally submitted. The completed voting ballot is displayed on a display to a ballot checker, and a scan path is overlaid, by the CPU, over the completed voting ballot, where the scan path is determined by an optimal search strategy. Each of the one or more races on the completed voting ballot is scanned using the scan path, where one or more ballot error indicators of the optimal search strategy identifies at least one ballot error on the completed voting ballot. The at least one ballot error is signaled on the display to the ballot checker.

### BACKGROUND

Voting can serve many purposes, such as choosing political leaders, electing members to a corporate board, participating in surveys conducted by government agencies, or making decisions on issues that affect a community or organization. Traditionally, voting is conducted using either electronic ballot machines or paper ballots. A single ballot may present voters with multiple contests or questions, and upon completing their selections, voters submit the ballot for official tabulation.

Ideally, voters should review their ballots for accuracy and completeness prior to submission. Research has demonstrated that there are optimal visual search strategies that can be used to help a voter detect malicious and accidental errors. However, voters often do not employ these advantageous visual scanning strategies, and subsequently, the voice of the voter can go unheard due to the submission of an erroneous ballot. Accordingly, there exists a need to assist a voter in following an optimized visual scanning strategy to identify and correct errors on a completed voting ballot prior to submission.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to a method for enhancing visual inspection of a completed voting ballot, the method comprising receiving, by a central processing unit (CPU), the completed voting ballot, wherein the completed voting ballot comprises one or more races, and wherein the completed voting ballot is an unsubmitted ballot that has not been finally submitted; displaying, by the CPU, the completed voting ballot on a display to a ballot checker; overlaying, by the CPU, a scan path over the completed voting ballot, wherein the scan path is determined by an optimal search strategy; scanning, by the CPU, each of the one or more races on the completed voting ballot using the scan path, wherein one or more ballot error indicators of the optimal search strategy identifies at least one ballot error on the completed voting ballot; and signaling, by the CPU, the at least one ballot error on the display.

In one aspect, embodiments disclosed herein relate to a system for enhancing a visual inspection of a completed voting ballot, the system comprising the completed voting ballot; a ballot checker; and a ballot checking device comprising a display; one or more processors; and a non-transitory computer-readable medium comprising computer-executable instructions stored thereon that, when executed on the one or more processors, cause the one or more processors to perform a method comprising receiving the completed voting ballot, wherein the completed voting ballot comprises one or more races, and wherein the completed voting ballot is an unsubmitted ballot that has not been finally submitted; displaying the completed voting ballot on the display to the ballot checker; overlaying a scan path over the completed voting ballot, wherein the scan path is determined by an optimal search strategy; scanning each of the one or more races on the completed voting ballot using the scan path, wherein the scanning identifies at least one ballot error; and signaling the at least one ballot error on the display.

Other aspects and advantages of the claimed subject matter will be apparent from the following description and the appended claims.

### BRIEF DESCRIPTION OF DRAWINGS

Specific embodiments of the disclosed technology will now be described in detail with reference to the accompanying figures. Like elements in the various figures are denoted by like reference numerals for consistency. The size and relative positions of elements in the drawings are not necessarily drawn to scale. For example, the shapes of various elements and angles are not necessarily drawn to scale, and some of these elements may be arbitrarily enlarged and positioned to improve drawing legibility. Further, the particular shapes of the elements as drawn are not necessarily intended to convey any information regarding the actual shape of the particular elements and have been solely selected for ease of recognition in the drawing.

FIG. 1 shows a scanning guidance interface in accordance with one or more embodiments.

FIG. 2 shows an optimal search strategy in accordance with one or more embodiments.

FIGS. 3A-3D show various forms of scan path indicators that can be used by a scanning guidance interface in accordance with one or more embodiments.

FIG. 4 shows a system in accordance with one or more embodiments.

FIGS. 5A-5C show a system in accordance with one or more embodiments.

FIG. 6 shows a flowchart in accordance with one or more embodiments.

FIG. 7 shows a computer system in accordance with one or more embodiments.

### DETAILED DESCRIPTION

In the following detailed description of embodiments of the disclosure, numerous specific details are set forth to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before,” “after,” “single,” and other such terminology. Rather, the use of ordinal numbers is to distinguish between the elements. By way of an example, a first element is distinct from a second element, and the first element may encompass more than one element and succeed (or precede) the second element in an ordering of elements.

It is to be understood that the singular forms “a,” “an,” and “the” include plural referents unless the context clearly dictates otherwise. For example, a “ballot error” may include any number of “ballot errors” without limitation.

Terms such as “approximately,” “substantially,” etc., mean that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

It is to be understood that one or more of the steps shown in the flowcharts may be omitted, repeated, and/or performed in a different order than the order shown. Accordingly, the scope disclosed herein should not be considered limited to the specific arrangement of steps shown in the flowcharts.

Although multiple dependent claims are not introduced, it would be apparent to one of ordinary skill that the subject matter of the dependent claims of one or more embodiments may be combined with other dependent claims.

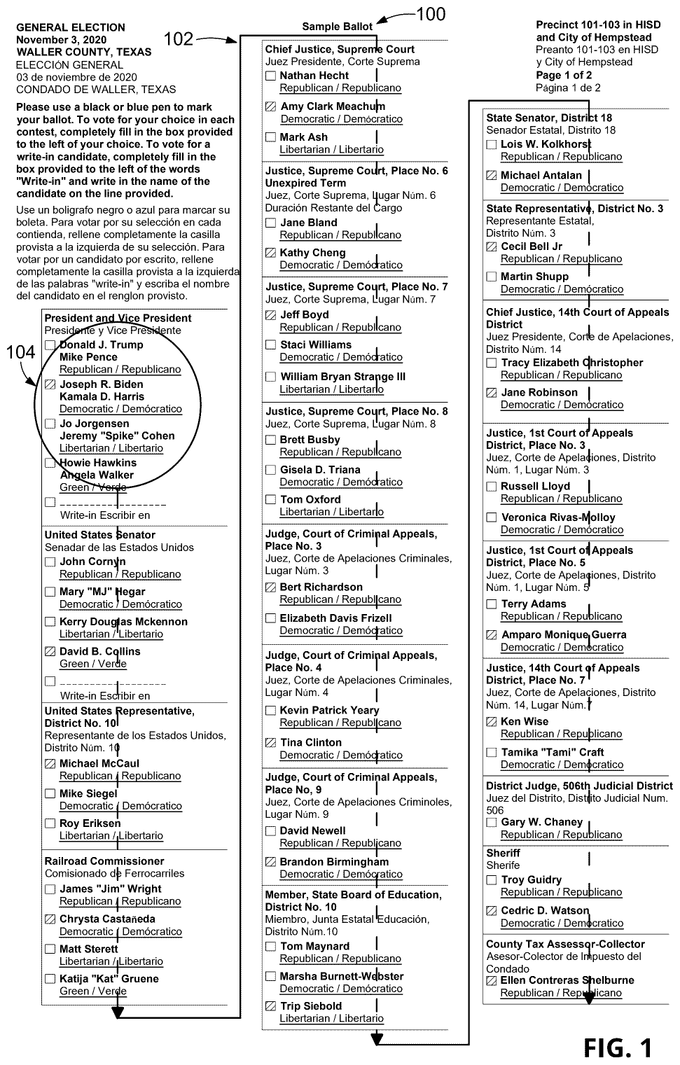

In the following description of FIGS. 1-7, any component described with regard to a figure, in various embodiments disclosed herein, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments disclosed herein, any description of the components of a figure is to be interpreted as an optional embodiment which may be implemented in addition to, in conjunction with, or in place of the embodiments described with regard to a corresponding like-named component in any other figure.

Although methods and systems described herein focus primarily on voting ballot technology, it would be apparent to one of ordinary skill that embodiments can be modified to be used in the detection of anomalous features, errors, or imperfections in a broad range of human-based inspection systems outside the realm of voting ballot technology. In particular, the methods and systems described herein may be applied in manufacturing, quality control, and any other fields that rely upon human inspectors for visual assessment and decision-making tasks.

Voting equipment currently in use can include hand-marked paper ballots, direct recording electronic (DRE) systems, and ballot-marking devices (BMDs). Voters using paper ballots typically mark votes by physically filling in a box or bubble on the paper ballot, and the completed voting ballot is then scanned by a machine or counted manually to record the ballot. A DRE system uses an interface such as a touchscreen, dial, or mechanical button as a means for a user to mark a vote on a ballot, and the completed voting ballot is then recorded directly into the memory of a computer. A BMD presents a ballot electronically on a display and allows a voter to make a selection electronically, but rather than recording the completed voting ballot into the memory of a computer, the completed voting ballot is physically printed in a human-readable format, and no lasting record of the completed voting ballot is saved on a computer. Regardless of the voting equipment used, errors both malicious and accidental can be made by a voter during the voting process.

Ballot errors may be malicious or non-malicious. A malicious ballot error is one in which an outside party (i.e., an entity different from the voter) has altered the ballot in a way that does not reflect the intent of the voter. For example, a malicious ballot error occurs when a hacker gains access to a voting device and alters the legitimate vote of a voter in favor a different candidate. A non-malicious error refers to an unintentional mistake made by a voter during the act of casting a ballot. This may occur when the selection of the voter does not reflect their actual intent, often due to oversight, confusion, or accidental input. For example, a non-malicious ballot error can occur when a voter intending to select one candidate for a particular office inadvertently selects a different candidate with a similar name due to inattention or a misclick. Further examples of ballot errors are discussed below.

Embodiments disclosed herein provide a method and system for facilitating the enhanced visual inspection of a voting ballot upon completion of the ballot, enabling a ballot checker in the identification of ballot errors prior to final submission of the completed ballot. Based on known visual scanning patterns, an optimal search strategy may be presented as an overlay over the completed voting ballot to aid the voter, herein also referred to as a ballot checker, in the identification of ballot errors on the completed voting ballot. Consequently, confirmed errors can be corrected by the ballot checker prior to the submission of the completed voting ballot.

Software may be developed to implement an optimal search strategy on voting technology or standalone inspection systems. Embodiments disclosed herein apply primarily to the use of screen-based voting equipment such as DRE systems and BMDs; however, embodiments can be applied to paper-based ballots with the addition of specific hardware and software.

Specific visual search strategies have been shown to improve the accuracy and efficiency of ballot error detection. These strategies, referred to herein as optimal search strategies, are derived from empirical studies and observational data involving ballot checkers. The identified optimal search strategies include specific visual scanning patterns that correlate with a higher rate of error identification on completed voting ballots. These patterns are not arbitrary; they are grounded in cognitive psychology and human factors research, which analyze how individuals visually process structured information. By systematically applying these optimal search strategies using the methods and systems disclosed herein, ballot checkers can enhance their ability to detect anomalies, inconsistencies, or other potential errors that may compromise ballot integrity.

In one or more embodiments, an optimal search strategy is one that maximizes the detection of errors by a ballot checker. In the current implementation, an optimal search strategy has been derived empirically by observing how individuals search ballots during experimental studies. Future implementations may rely on cognitive models of human behavior to determine such strategies more systematically. It is important to note that an optimal search strategy is highly dependent on the specific design and structure of the ballot (in the context of voting implementations). Consequently, a single, fixed strategy cannot be universally applied to all ballots; instead, the search strategy must be adapted to the particular form of each ballot.

By way of example and without limitation, research conducted in connection with the development of the present systems and methods has identified several search strategies as exhibiting optimal performance characteristics, to varying degrees. During said research, eye-tracking technology was utilized to capture the visual scan path of a ballot checker during review of a completed voting ballot, wherein such scan paths were analyzed to identify those associated with the highest error detection rates. In one embodiment, ballot checkers were instructed to inspect a ballot using a search strategy of their own choosing. During this process, the movement of the gaze of the ballot checker was monitored and recorded. Upon completion of the review, the number of errors detected by the participant was counted. This empirical data enables the evaluation of search strategy effectiveness by correlating the scan path with the number of errors identified, thereby facilitating the determination of optimal search strategies. The following optimal search strategies were identified: Top-to-bottom-left-to-right, Random, Snake, Top-middle-top-left-top-right, Bottom-middle, Bottom-middle-bottom-top, Top-left-snake, Top-middle-bottom-left-top-right, and Top-middle-top-right-top-left. The identified optimal search strategies are described in greater detail below.

Top-to-bottom-left-to-right is characterized by a ballot checker implementing a sequential reading approach, initiating the review at the top-left corner of the ballot, proceeding horizontally across the top row to the top-right corner of the first column, and continuing in a top-to-bottom, left-to-right row-wise progression consistent with conventional reading patterns.

Random is characterized by a ballot checker employing a non-sequential, randomized approach, wherein the checker selects a race at random and subsequently transitions to other races in a similarly random manner until the ballot checker determines the review process is complete.

Snake is characterized by a ballot checker initiating the review at the top-left corner, scanning rightward across the first row, and upon reaching the end of the row, descending to the next row and scanning leftward, continuing in an alternating, bidirectional “snake-like” pattern across the ballot.

Top-middle-top-left-top-right is characterized by a ballot checker initiating the review at the topmost race within the middle column, followed by reviewing the topmost race within the leftmost column, and concluding with the topmost race in the rightmost column.

Bottom-middle is characterized by a ballot checker restricting the review to races located in the middle column of the ballot, beginning with the bottommost race and proceeding upward through the column.

Bottom-middle-bottom-top is characterized by a ballot checker reviewing only the middle and top columns of the ballot, commencing at the bottommost race and progressing upward through each applicable column.

Top-left-snake is characterized by a ballot checker reviewing only the leftmost column of the ballot, beginning with the topmost race and continuing in an alternating directional or “snake” pattern across the subsequent rows.

Top-middle-bottom-left-top-right is characterized by a ballot checker initiating the review at the topmost race in the middle column, continuing to the bottommost race in the leftmost column, and concluding with the topmost race in the rightmost column.

Top-middle-top-right-top-left is characterized by a ballot checker beginning at the topmost race in the middle column, proceeding to the topmost race in the rightmost column, and then reviewing the topmost race in the leftmost column.

In one or more embodiments, an optimal search strategy includes a scan path. The scan path may represent a visual depiction of the sequence in which a ballot checker inspects each contest or race on a completed voting ballot for potential errors, in accordance with the optimal search strategy being applied.

Embodiments of the disclosure may present the scan path of an optimal search strategy as a visual overlay over the completed voting ballot to aid the ballot checker in the identification of ballot errors on the completed voting ballot. The scan path may begin at the appropriate starting point on the completed voting ballot, and then proceed to move through each race of the completed voting ballot along the scan path, according to the optimal search strategy. On a screen-based voting device, hereinafter referred to as a voting device, the scan path may be superimposed on top of the completed voting ballot displayed on a screen.

A scanning guidance interface can be used to visually represent the optimal search strategy to the ballot checker. A scanning guidance interface may include the scan path and a scan path indicator. A scan path indicator may be a visual aid to signal the race currently being examined along the scan path. The form of the scanning guidance interface can vary in many ways, such as, by non-limiting example, the arrangement of the scan path, the size, shape, and color of the scan path indicator, and the temporal rate of inspection of each race.

In one or more embodiments of the scanning guidance interface, the ballot checker inspects a completed voting ballot as the scan path indicator automatically proceeds at a designated pace consecutively through each individual race on the completed voting ballot according to the scan path of the optimal search strategy being applied. In another embodiment of the scanning guidance interface, the ballot checker controls the pace of the inspection of the completed voting ballot. For example, the ballot checker can inspect each race on the completed voting ballot at an individual pace, according to the scan path of the optimal search strategy being applied. Upon completing the inspection of a given race, the ballot checker may activate a designated control (e.g., a button) to advance the scan path indicator to the next race designated for inspection. In all embodiments, the inspection would proceed along the scan path according to an optimal search strategy.

In one or more embodiments, the method and system is configured to identify different types of potential ballot errors on a completed voting ballot. In particular, under-voting may be a primary failure, or ballot error, that can be detected on a completed voting ballot. Under-voting occurs when a voter fails to make the necessary number of votes, or selections, in a race. Another ballot error that may be detected on a completed ballot is over-voting. Over-voting occurs when a voter makes too many votes, or selections, in a race. Over-voting more commonly occurs on a paper-based voting ballot. A further ballot error that may occur on a paper-based voting ballot is an anomalous mark that cannot be interpreted, such as, by non-limiting example, a stray mark, an incomplete bubble fill, or using an incorrect mark to fill a bubble. Those knowledgeable in the art can appreciate that there are a number of ballot errors that can occur on a voting ballot, especially in the case of a physical, paper-based voting ballot.

As discussed, ballot errors can be malicious or non-malicious in nature. It is evident that a vote alteration, or “flipped vote,” introduced by an unauthorized third party constitutes a malicious act. Similarly, undervotes, overvotes, and stray marks may also be considered malicious if they result from the actions of such a third party. Stray marks are limited to paper ballots, as they are a physical artifact. While overvotes are generally prevented in computer-based ballot interfaces, a malicious actor could potentially introduce an overvote on the printed version of a ballot. Additionally, an undervote may be deemed malicious in cases where a voter had originally selected a candidate, and the selection was subsequently removed or deselected by an unauthorized third party.

In one or more embodiments, an optimal search strategy includes ballot error indicators. Ballot error indicators can be visual or functional markers used by an algorithm to determine if a potential ballot error exists on a completed voting ballot. Thus, an optimal search strategy can include ballot error indicators that may be an indication of a ballot error on a completed voting ballot. Non-limiting examples of ballot error indicators may be over-voting, under-voting, misspellings, omissions, and anomalous or unexpected marks on the completed voting ballot. Outside of the voting domain, non-limiting examples of ballot error indicators may be a wrong setting on a device, a cosmetic flaw, a tear or break in a component, or a missing mark/word/warning/decal.

In some embodiments, eye-tracking technology can be used to determine where a ballot checker is looking with respect to the completed voting ballot. The use of eye-tracking technology may be beneficial to ensure the ballot checker is following the scan path according to the optimal search strategy. Specifically, in scenarios where a scan path is continuous and does not require ballot checker confirmation after the examination of each individual race on a ballot, eye-tracking technology may determine whether the ballot checker is viewing the correct race along the scan path and whether the ballot checker is viewing the correct race for a suitable length of time. Essentially, the eye tracking coils of an eye-tracking device ensure that the ballot checker is performing the expected actions during the ballot completion process for each race.

Eye-tracking systems may be calibrated by instructing a ballot checker to fixate on a series of predefined reference points with known spatial coordinates. These reference points are then utilized to align and calibrate subsequent eye-tracking measurements. Eye-tracking systems may also be adjusted for distance to alter the spatial separation between the eye of a ballot checker and the eye-tracking measurement system. Various configurations of eye-tracking systems exist, with some systems positioning the sensing apparatus in close proximity to the eye (e.g., within a few centimeters), while others operate effectively at greater distances, potentially up to several feet.

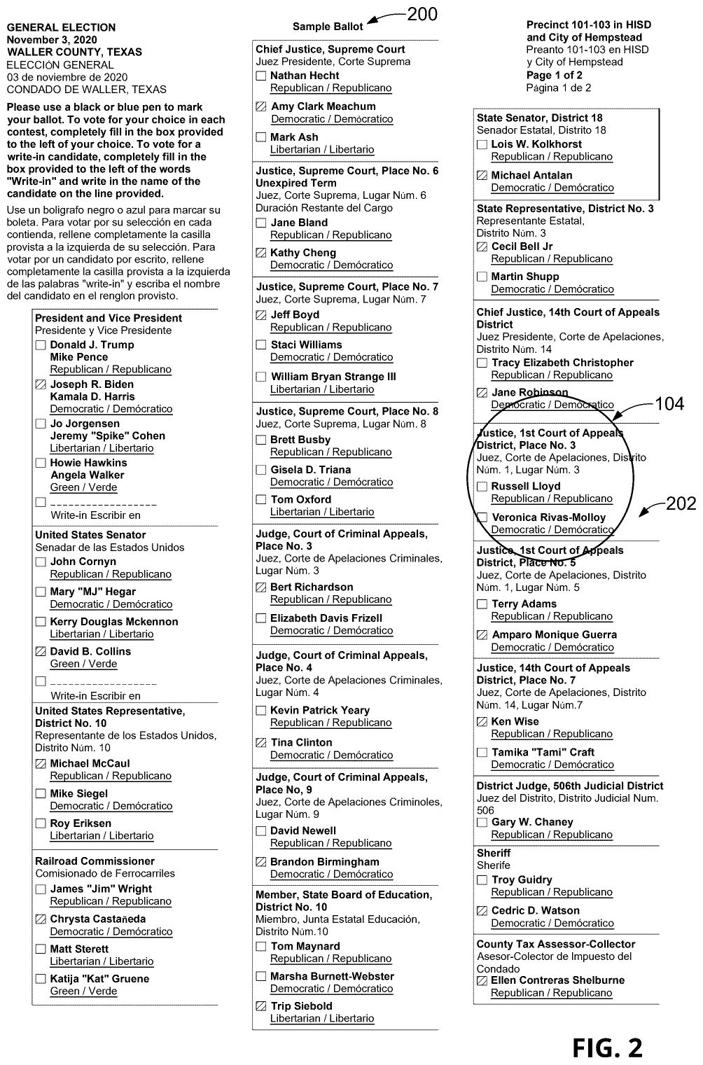

FIG. 1 shows an example of a scanning guidance interface, in one or more embodiments. A sample completed voting ballot 100 is depicted overlaid by a scanning guidance interface that includes a scan path 102 and a scan path indicator 104. The illustrated example depicts the implementation of an optimal search strategy characterized by a Top-to-bottom-left-to-right scanning pattern. In the example, the scan path indicator 104 is shown as a circle with a solid line, and the dashed line indicates the scan path 102. During the inspection of the sample completed voting ballot 100 by the ballot checker, each race on the sample completed voting ballot 100 may be examined in an order according to the scan path 102 of the optimal search strategy being applied. As discussed, the scan path indicator 104 serves as a visual aid to signal the race currently being examined along the scan path 102. FIG. 2 shows an example optimal search strategy that includes omissions as a ballot error indicator, in one or more embodiments. Depicted is a completed voting ballot 200 in which a voter has failed to vote in one of the races. This type of ballot error may be referred to as an under-voting error 202. The under-voting error 202 can be identified by the method and system during the implementation of the optimal search strategy. As the ballot checker is led through the scan path 102 (not shown) by the scan path indicator 104, the scanning guidance interface can be configured to change the color of the scan path indicator 104 to identify or signal the under-voting error 202 to the ballot checker. For example, the outline of the scan path indicator 104 may change from blue to red to indicate that a ballot error has been identified. Additionally, in certain embodiments, including the embodiment illustrated in FIG. 2, the scan path 102 may be concealed from the ballot checker. The overlay of the scan path 102 on the completed voting ballot need not be visually presented to the ballot checker. In such cases, a scan path indicator 104 may be employed to guide the ballot checker along the scan path 102 by indicating the specific race currently subject to inspection.

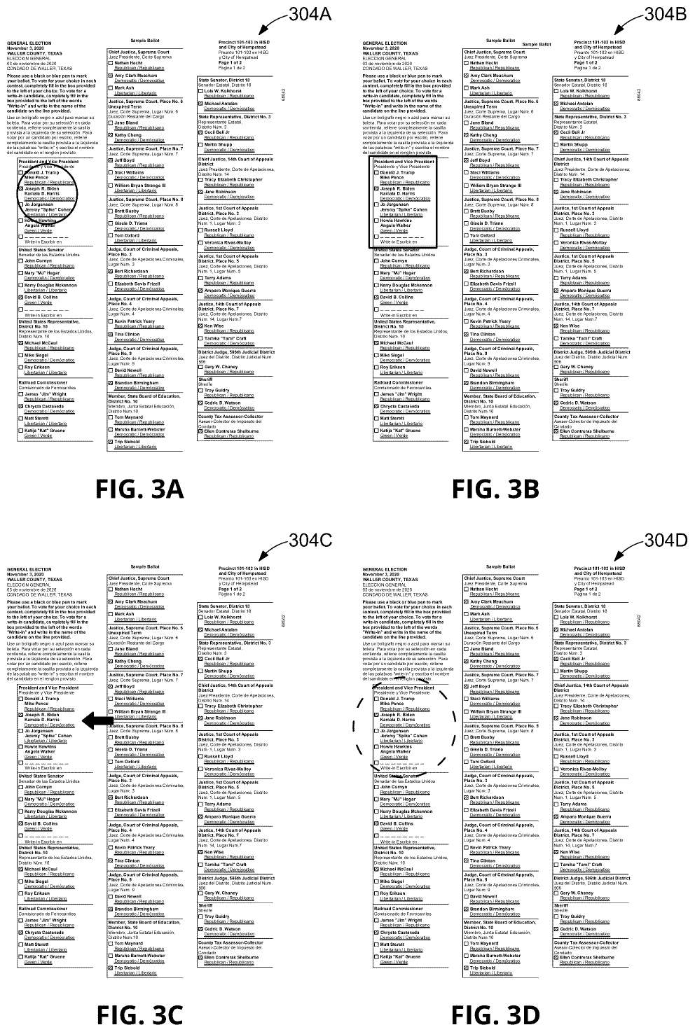

FIGS. 3A-3D depict different examples of a scan path indicator 104 that can be used by a scanning guidance interface, in one or more embodiments. FIG. 3A shows a scan path indicator 304a in the form of a circle. FIG. 3B shows a scan path indicator 304b in the form of a rectangle. FIG. 3C shows a scan path indicator 304c in the form of a solid arrow. FIG. 3D shows a scan path indicator 304d in the form of a dashed circle. The exact form of the scan path indicator 104 is nearly limitless and can take any shape, size, opacity, or color depending upon the needs of the ballot system or other human-based inspection task.

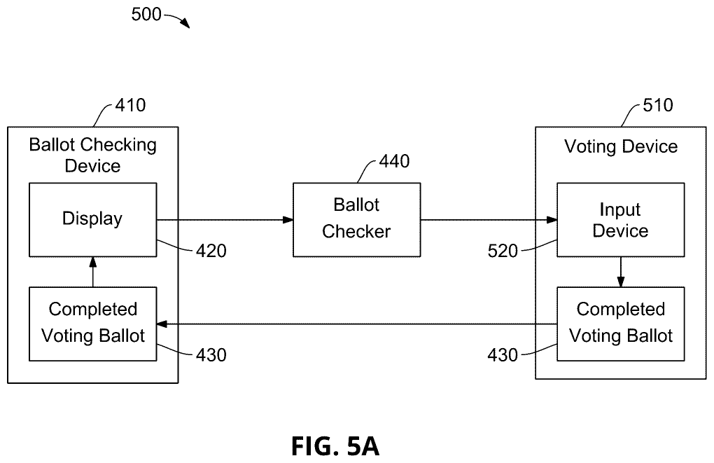

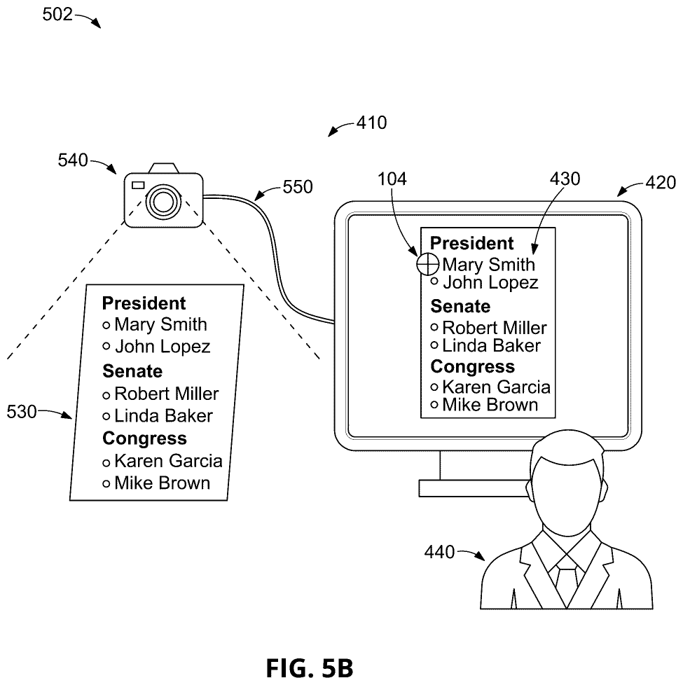

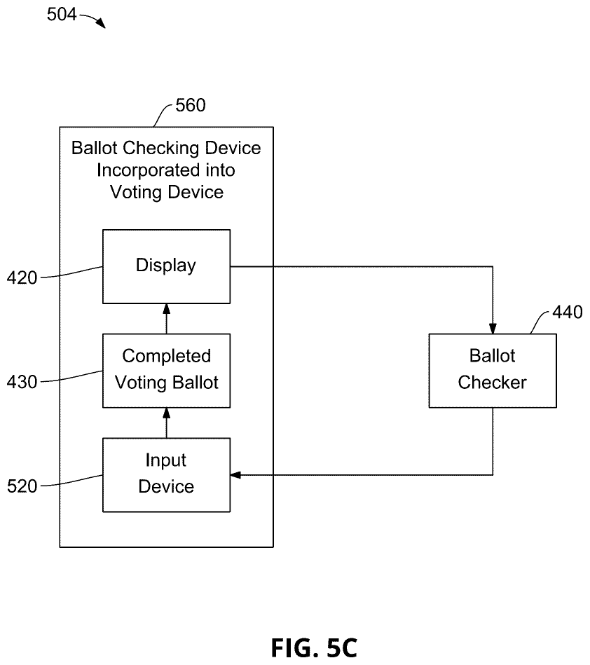

As discussed, embodiments disclosed herein apply primarily to the use of standalone inspection systems or screen-based voting equipment such as DRE systems and BMDs. To implement the method and system on a paper-based ballot system, additional hardware/software components may be utilized, such as scanners, cameras, or augmented reality devices (see FIG. 5B, as described below).

Additionally, as described above, embodiments of the method and systems described herein can be modified to be used in the detection of anomalous features, errors, or imperfections in a broad range of human-based inspection systems outside the realm of voting ballot technology. Empirical data may be utilized to establish an optimal search strategy for the inspection of any physical object and the subsequent detection of anomalous features thereof, and a corresponding scanning guidance interface may be integrated into the inspection system. In particular, the methods and systems described herein may be applied in manufacturing, quality control, and other fields that rely on human inspectors for visual assessment and decision-making tasks. Non-limiting examples of operations that utilize human inspectors include product assembly lines, textile or fabric inspection, electronics inspection, vehicle inspection, aircraft maintenance, building/bridge/tunnel inspections, inspection of medical products and devices, and food packaging and product inspection.

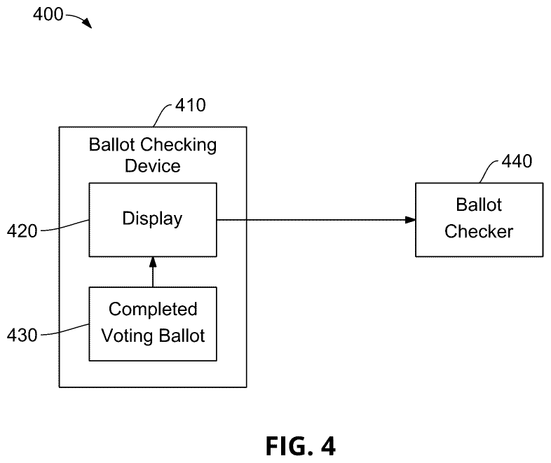

Embodiments disclosed herein generally relate to a system for enhancing visual inspection of a completed voting ballot. An example system in accordance with one or more embodiments of the disclosure is the visual ballot checking system 400 illustrated in FIG. 4. The system includes a ballot checking device 410, a completed voting ballot 430, and a ballot checker 440.

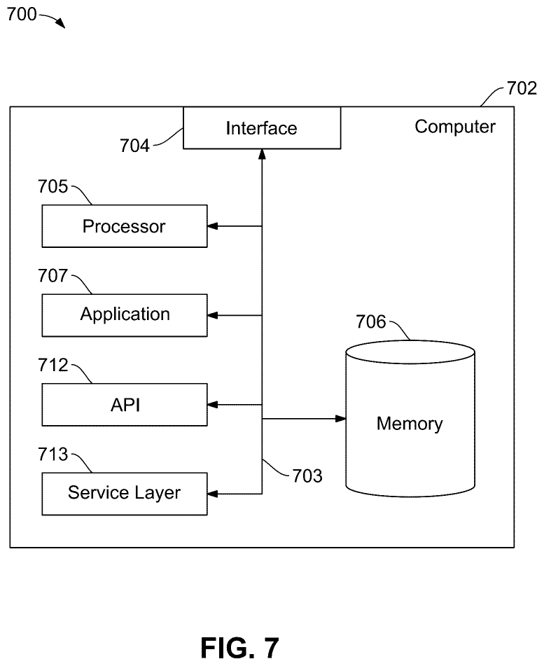

The ballot checking device 410 includes a display 420 operatively connected to the ballot checking device 410. The ballot checking device 410 also includes one or more processors and a non-transitory computer-readable medium comprising computer-executable instructions stored thereon (e.g., a computer system as illustrated in FIG. 7).

The ballot checking device 410 is configured to use the one or more processors to receive the completed voting ballot 430. A completed voting ballot 430 can be an unsubmitted ballot that has been completed by a voter but has not been finally submitted, cast, or otherwise officially recorded. A completed voting ballot 430 can include any number of races, contests, questions, or other items that require a human to cast a vote or make a selection. The completed voting ballot 430 may be received from, for example, a voting device or an imaging device, which will be described further in FIGS. 5A-5B below.

The ballot checking device 410 may be further configured to use the one or more processors to display the completed voting ballot 430 on the display 420 to the ballot checker 440. The ballot checker 440 can be, for example, the voter who completed the completed voting ballot 430, or the ballot checker 440 may be a person, different from the voter, who is tasked with inspecting the completed voting ballot 430. Examples of a display 420 can include, but are not limited to, a liquid crystal display (LCD), a plasma display, touchscreen, cathode ray tube (CRT) monitor, projector, a mobile device, and an augmented reality (AR) wearable device (such as a head-mounted display (HMD) or smart glasses).

The ballot checking device 410 may be further configured to use the one or more processors to overlay a scan path 102 over the completed voting ballot 430, where the scan path 102 may be determined by an optimal search strategy. The scan path 102 may be visible or transparent (not visible) to the ballot checker 440. The scan path indicator 104 that follows the scan path 102 may be visible to the ballot checker 440.

The ballot checking device 410 may be further configured to use the one or more processors to scan each of the one or more races on the completed voting ballot 430 according to the scan path 102. In one or more embodiments, scanning each of the one or more races may include utilizing a scanning guidance interface to visually present the scan path 102 to the ballot checker 440 on the display 420, where the scanning guidance interface includes a scan path indicator 104 configured to indicate to the ballot checker 440 which of the one or more races is currently being scanned. The scan path indicator 104 can be represented by one or more characteristics, as shown in FIGS. 1-3. Non-limiting examples of the one or more characteristics are color, shape, size, and opacity. For instance, the scan path indicator 104 can be a blue arrow, a transparent circle, or a shaded rectangle.

In one or more embodiments, the scanning of the completed voting ballot 430 may result in the identification of at least one ballot error. An optimal search strategy may include one or more ballot error indicators, which can be visual or functional markers used to determine if a ballot error exists on a completed voting ballot 430. Non-limiting examples of ballot error indicators may be misspellings, omissions, and anomalous or unexpected marks on the completed voting ballot 430. The at least one ballot error is identified using the one or more ballot error indicators of the applicable optimal search strategy. Once identified, the at least one ballot error may be highlighted or signaled to the ballot checker 440 by changing the one or more characteristics of the scan path indicator 104. For example, a scan path indicator 104 initially displayed as a green arrow may change to a red arrow when it points to a race where a ballot error has been identified.

In some embodiments, the ballot checking device 410 may include an eye-tracking device configured to track a sight line of the ballot checker 440. The eye-tracking device may be incorporated into an augmented reality (AR) wearable device (such as a head-mounted display (HMD) or smart glasses) or other type of eye-tracking hardware that uses cameras or infrared sensors to detect the position and movement of the eyes of a ballot checker 440 relative to the completed voting ballot 430 on the display 420. By way of non-limiting example, the eye-tracking device may be a Gazepoint GP3 eye tracking-unit. The Gazepoint GP3 is a compact, research-grade eye-tracking device designed to be mounted on a computer display. It accurately captures and records the gaze behavior of a user, including where and how the user looks at on-screen content. The device is well-suited for applications such as usability testing, academic research, marketing analysis, assistive technology, and the study and development of human-computer interaction.

FIGS. 5A-5C show alternative arrangements of the visual ballot checking system 400, in accordance with one or more embodiments.

Visual ballot checking system 500, as depicted in FIG. 5A, includes the ballot checking device 410, the completed voting ballot 430, the ballot checker 440, and a voting device 510. The voting device 510 may be voting equipment such as, for example, a DRE system or a BMD, that includes an input device 520 operatively connected to the voting device 510. Non-limiting examples of an input device 520 can include a keyboard, mouse, microphone, camera, touchpad, or scanner. The voting device 510 may also include one or more processors and a non-transitory computer-readable medium comprising computer-executable instructions stored thereon (e.g., a computer system as illustrated in FIG. 7).

As depicted in FIG. 5A, completed voting ballot 430 may originate from voting device 510. Ballot checking device 410 may receive a digital copy of completed voting ballot 430 from voting device 510 via one-way direct or indirect transmission from voting device 510.

Subsequent to signaling the ballot checker 440 to at least one ballot error on the digital copy of the completed voting ballot 430 via display 420, the input device 520 of voting device 510 is configured to receive input from the ballot checker 440. The input can include at least one ballot correction corresponding to the at least one ballot error found during the scanning of the completed voting ballot 430 by the ballot checking device 410. The one or more processors of the voting device 510 are configured to then revise the completed voting ballot 430 using the input from the ballot checker 440. Upon correction of the completed voting ballot 430, the completed voting ballot 430 can be finally submitted via the voting device 510.

FIG. 5B illustrates visual ballot checking system 502, in accordance with one or more embodiments. Visual ballot checking system 502 includes the ballot checking device 410, the completed voting ballot 430, the ballot checker 440, and a physical completed voting ballot 530. The physical completed voting ballot 530 may be, for example, a paper ballot. The ballot checking device 410 of visual ballot checking system 502 further includes an imaging device 540 operatively connected to the ballot checking device 410 via connection 550. Non-limiting examples of imaging device 540 can include a camera or a scanner. Non-limiting examples of connection 550 can be wired (i.e., ethernet, USB, HDMI), wireless (i.e., wi-fi, Bluetooth, infrared), network-level (i.e., fiber optic, DSL, VPN) or internal to ballot checking device 410 (i.e., Peripheral Component Interconnect Express, Inter-integrated/Serial Peripheral Interface).

In one or more embodiments, the one or more processors of the ballot checking device 410 are configured to capture an image of the physical completed voting ballot 530 via imaging device 540. The one or more processors of the ballot checking device 410 are further configured to store the image as the completed voting ballot 430 to the non-transitory computer-readable medium of the ballot checking device 410. Thus, in visual ballot checking system 502, ballot checking device 410 receives completed voting ballot 430 via imaging device 540. The ballot checking device 410 may be further configured to use the one or more processors to overlay a scan path 102 over the completed voting ballot 430, where the scan path 102 may be determined by an optimal search strategy. The scan path 102 may be either visually presented to the ballot checker 440 or rendered transparent such that it is not visible. In certain embodiments, a scan path indicator 104 configured to traverse the scan path 102 may be visible to the ballot checker 440, thereby providing guidance as to the current area of focus during the ballot review process.

The ballot checking device 410 may be further configured to use the one or more processors to scan each of the one or more races on the completed voting ballot 430 according to the scan path 102. In one or more embodiments, scanning each of the one or more races may include utilizing a scanning guidance interface to visually present the scan path 102 to the ballot checker 440 on the display 420, where the scanning guidance interface includes a scan path indicator 104 configured to indicate to the ballot checker 440 which of the one or more races is currently being scanned. The scan path indicator 104 can be represented by one or more characteristics, as shown in FIGS. 1-3. Non-limiting examples of the one or more characteristics are color, shape, size, and opacity. For instance, the scan path indicator 104 can be a blue arrow, a transparent circle, or a shaded rectangle.

Subsequent to signaling the ballot checker 440 to the at least one ballot error on the completed voting ballot 430 via display 420, the ballot checker 440 can physically mark at least one ballot correction corresponding to the at least one ballot error on the physical completed voting ballot 530. Upon correction of the physical completed voting ballot 530, the corrected physical completed voting ballot 530 can be finally submitted.

Visual ballot checking system 502 demonstrates how the system can be used when the completed voting ballot 430 exists in a physical format, such as a paper ballot. However, a person of ordinary skill can envision how visual ballot checking system 502 can be modified such that ballot checking device 410 is a physical overlay over the display of the voting device 510 or ballot checking device 410 is an AR wearable device directed towards the display of the voting device 510. A primary advantage of using visual ballot checking system 502 is the enhanced security and integrity it provides for the voting device 510. This is achieved because the system does not require any physical connection to the voting device 510. Additionally, no software needs to be installed or deployed onto the voting device 510, reducing the risk of tampering or interference by a malicious actor.

FIG. 5C illustrates visual ballot checking system 504, in accordance with one or more embodiments. Visual ballot checking system 504 includes a ballot checking device incorporated into a voting device 560 and ballot checker 440. In this embodiment of the system, ballot checking device incorporated into a voting device 560 includes all of the functionality of ballot checking device 410 and voting device 510. Such an embodiment requires the installation of ballot checking device software directly onto voting device 510, in addition to any further elements such as an imaging device 540 or an eye-tracking device.

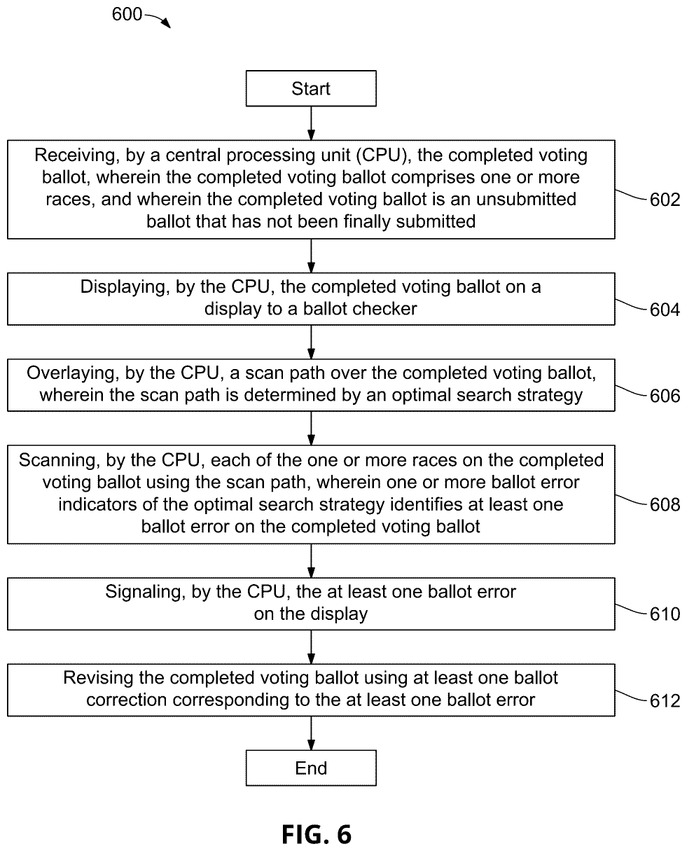

A flowchart in accordance with one or more embodiments of the disclosure is shown in FIG. 6. Specifically, FIG. 6 describes a general method for enhancing visual inspection of a completed voting ballot 600. The method may be implemented on a visual ballot checking system 400, 500, 502, 504 using instructions stored on a non-transitory medium that may be executed by a computer 702 system as shown in FIG. 7. While the various steps in FIG. 6 are presented and described sequentially, one of ordinary skill in the art will appreciate that some or all of the blocks may be executed in different orders, may be combined or omitted, and some or all of the blocks may be executed in parallel. Furthermore, the blocks may be performed actively or passively.

Initially, Block 602 describes receiving, by a central processing unit (CPU), a completed voting ballot 430. As described above, the completed voting ballot 430 can be an unsubmitted ballot that has been completed by a voter, but has not been finally submitted, cast, or otherwise officially recorded. The completed voting ballot 430 can include any number of races, contests, questions, or other items that require a human to cast a vote or make a selection. The completed voting ballot 430 may be received from, for example, a voting device 510 or an imaging device 540.

Block 604 describes displaying, by the CPU, the completed voting ballot 430 on a display 420 to a ballot checker 440. The display 420 is operatively coupled to the CPU. The ballot checker 440 can be, for example, the voter who completed the completed voting ballot 430, or the ballot checker 440 may be a person, different from the voter, who is tasked with inspecting the completed voting ballot 430.

Block 606 describes overlaying, by the CPU, a scan path 102 over the completed voting ballot 430, where the scan path 102 may be determined by an optimal search strategy. As described above, the scan path 102 may be either visually presented to the ballot checker 440 or rendered transparent such that it is not visible. In certain embodiments, a scan path indicator 104 configured to traverse the scan path 102 may be visible to the ballot checker 440, thereby providing guidance as to the current area of focus during the ballot review process.

Block 608 describes scanning, by the CPU, each of the one or more races on the completed voting ballot 430 in accordance with the scan path 102. In one or more embodiments, scanning each of the one or more races may include utilizing, by the CPU, a scanning guidance interface to visually present the scan path 102 to the ballot checker 440 on the display 420, where the scanning guidance interface includes a scan path indicator 104 configured to indicate to the ballot checker 440 which of the one or more races is currently being scanned. The scan path indicator 104 can be represented by one or more characteristics, as shown in FIGS. 1-3. Non-limiting examples of the one or more characteristics are color, shape, size, and opacity. For instance, the scan path indicator 104 can be a blue arrow, a transparent circle, or a shaded rectangle.

Continuing with block 608, in one or more embodiments, during the scanning, one or more ballot error indicators of the optimal search strategy identifies at least one ballot error on the completed voting ballot. As described above, an optimal search strategy may include one or more ballot error indicators, which can be visual or functional markers used to determine if a ballot error exists on a completed voting ballot 430. Non-limiting examples of ballot error indicators may be misspellings, omissions, and anomalous or unexpected marks on the completed voting ballot. The at least one ballot error is identified using the one or more ballot error indicators of the applicable optimal search strategy.

Block 610 describes signaling, by the CPU, the at least one ballot error on the display 420 to the ballot checker 440. The at least one ballot error may be highlighted or signaled to the ballot checker 440 by changing the one or more characteristics of the scan path indicator 104. For example, a scan path indicator 104 initially displayed as a green arrow may change to a red arrow when it points to a race where a ballot error has been identified.

Block 612 describes revising the completed voting ballot 430 using at least one ballot correction corresponding to the at least one ballot error. The step of revising the completed voting ballot 430 can be performed in different ways, depending upon the arrangement of the voting environment. For example, in one embodiment of the method, such as a method performed by Visual Ballot Checking System 500 in FIG. 5A, the completed voting ballot 430 is received from a voting device 510. The voting device 510 may be voting equipment such as, for example, a DRE system or a BMD, that includes an input device 520 operatively connected to the voting device 510. The voting device 510 may also include one or more processors and a non-transitory computer-readable medium comprising computer-executable instructions stored thereon (e.g., a computer system as illustrated in FIG. 7). The CPU may receive a digital copy of completed voting ballot 430 from voting device 510 via one-way direct or indirect transmission from voting device 510. In one or more embodiments, the voting device 510 includes the CPU.

Subsequent to signaling the ballot checker 440 to at least one ballot error on the digital copy of the completed voting ballot 430 via display 420, the revision to the completed voting ballot 430 can be performed. Voting device 510 may receive input from the ballot checker 440 through an input device 520. The input can include at least one ballot correction corresponding to the at least one ballot error found during the scanning of the completed voting ballot 430 by the ballot checking device 410. Embodiments of the method further include revising, by the voting device 510, the completed voting ballot 430 using the input from the ballot checker 440. Upon correction of the completed voting ballot 430, the revised completed voting ballot 430 can be finally submitted via the voting device 510.

In the case where the completed voting ballot 430 exists in a physical format, such as a method performed by Visual Ballot Checking System 502 shown in FIG. 5A, the completed voting ballot 430 may be received from an imaging device 540 operatively coupled to the CPU. Accordingly, embodiments of the method further include capturing an image of a physical completed voting ballot 530 via an imaging device 540 operably coupled to the CPU and subsequently storing the image as the completed voting ballot 430 to a non-transitory storage medium operably coupled to the CPU.

Upon signaling the ballot checker 440 to the at least one ballot error on the completed voting ballot 430 via display 420, the revision to the completed voting ballot 430 can be performed. The ballot checker 440 can physically mark at least one ballot correction corresponding to the at least one ballot error on the physical completed voting ballot 530. Once the correction of the physical completed voting ballot 530 is done, the revised physical completed voting ballot 530 can be finally submitted.

In some embodiments of the method, the CPU may utilize eye-tracking technology configured to track a sight line of the ballot checker 440. As described above, an eye-tracking device may be incorporated into an augmented reality (AR) wearable device (such as a head-mounted display (HMD) or smart glasses) or other type of eye-tracking hardware that uses cameras or infrared sensors to detect the position and movement of the eyes of a ballot checker 440 relative to the completed voting ballot 430 on the display 420. The use of eye-tracking technology may be beneficial to ensure the ballot checker 440 is following the scan path 102 according to the optimal search strategy. Specifically, in scenarios where a scan path 102 is continuous and does not require ballot checker confirmation after the examination of each individual race on the completed voting ballot 430, eye-tracking technology may determine whether the ballot checker 440 is viewing the correct race along the scan path 102 and whether the ballot checker 440 is viewing the correct race for a suitable length of time. Essentially, the eye tracking coils of an eye-tracking device ensure that the ballot checker 440 is performing the expected actions during the ballot completion process for each race.

Embodiments disclosed herein may be implemented on a computer system. FIG. 7 is a block diagram of a computer system (702) used to provide computational functionalities associated with described algorithms, methods, functions, processes, flows, and procedures as described in this disclosure, according to one or more embodiments. The illustrated computer (702) is intended to encompass any computing device such as a server, desktop computer, laptop/notebook computer, wireless data port, smart phone, wearable device, personal data assistant (PDA), tablet computing device, one or more processors within these devices, or any other suitable processing device, including both physical or virtual instances (or both) of the computing device. Additionally, the computer (702) may include an input device, such as a keypad, keyboard, touch screen, or other device that can accept user information, and an output device that conveys information associated with the operation of the computer (702), including digital data, visual, or audio information (or a combination of information), or a GUI. It will be understood that the computer system may be on board a wearable device combined with physiological sensors or the computer system may be in communication with one or more of the physiological sensors, an output device, and the wearable device. The output device may output the forecast in the form of a digital readout and/or an alarm.

The computer (702) can serve in a role as a client, network component, a server, a database or other persistency, or any other component (or a combination of roles) of a computer system for performing the subject matter described in the instant disclosure. The illustrated computer (702) may be communicably coupled with a network. In some implementations, one or more components of the computer (702) may be configured to operate within environments, including cloud-computing-based, local, global, or other environment (or a combination of environments).

At a high level, the computer (702) is an electronic computing device operable to receive, transmit, process, store, or manage data and information associated with the described subject matter. According to some implementations, the computer (702) may also include or be communicably coupled with an application server, e-mail server, web server, caching server, streaming data server, business intelligence (BI) server, or other server (or a combination of servers).

The computer (702) can receive requests over the network from a client application (for example, executing on another computer (702)) and responding to the received requests by processing the said requests in an appropriate software application. In addition, requests may also be sent to the computer (702) from internal users (for example, from a command console or by other appropriate access method), external or third-parties, other automated applications, as well as any other appropriate entities, individuals, systems, or computers.

Each of the components of the computer (702) can communicate using a system bus (703). In some implementations, any or all of the components of the computer (702), both hardware or software (or a combination of hardware and software), may interface with each other or the interface (704) (or a combination of both) over the system bus (703) using an application programming interface (API) (712) or a service layer (713) (or a combination of the API (712) and service layer (713)). The API (712) may include specifications for routines, data structures, and object classes. The API (712) may be either computer-language independent or dependent and refer to a complete interface, a single function, or even a set of APIs. The service layer (713) provides software services to the computer (702) or other components (whether or not illustrated) that are communicably coupled to the computer (702). The functionality of the computer (702) may be accessible for all service consumers using this service layer. Software services, such as those provided by the service layer (713), provide reusable, defined business functionalities through a defined interface. For example, the interface may be software written in JAVA, C++, or other suitable language providing data in extensible markup language (XML) format or another suitable format. While illustrated as an integrated component of the computer (702), alternative implementations may illustrate the API (712) or the service layer (713) as stand-alone components in relation to other components of the computer (702) or other components (whether or not illustrated) that are communicably coupled to the computer (702). Moreover, any or all parts of the API (712) or the service layer (713) may be implemented as child or sub-modules of another software module, enterprise application, or hardware module without departing from the scope of this disclosure.

The computer (702) includes an interface (704). Although illustrated as a single interface (704) in FIG. 7, two or more interfaces (704) may be used according to particular needs, desires, or particular implementations of the computer (702). The interface (704) is used by the computer (702) for communicating with other systems in a distributed environment that are connected to the network. Generally, the interface (704) includes logic encoded in software or hardware (or a combination of software and hardware) and operable to communicate with the network. More specifically, the interface (704) may include software supporting one or more communication protocols associated with communications such that the network or interface's hardware is operable to communicate physical signals within and outside of the illustrated computer (702).

The computer (702) includes at least one computer processor (705). Although illustrated as a single computer processor (705) in FIG. 7, two or more processors may be used according to particular needs, desires, or particular implementations of the computer (702). Generally, the computer processor (705) executes instructions and manipulates data to perform the operations of the computer (702) and any algorithms, methods, functions, processes, flows, and procedures as described in the instant disclosure.

The computer (702) also includes a memory (706) that holds data for the computer (702) or other components (or a combination of both) that can be connected to the network. For example, memory (706) can be a database storing data consistent with this disclosure. Although illustrated as a single memory (706) in FIG. 7, two or more memories may be used according to particular needs, desires, or particular implementations of the computer (702) and the described functionality. While memory (706) is illustrated as an integral component of the computer (702), in alternative implementations, memory (706) can be external to the computer (702).

The application (707) is an algorithmic software engine providing functionality according to particular needs, desires, or particular implementations of the computer (702), particularly with respect to functionality described in this disclosure. For example, application (707) can serve as one or more components, modules, applications, etc. Further, although illustrated as a single application (707), the application (707) may be implemented as multiple applications (707) on the computer (702). In addition, although illustrated as integral to the computer (702), in alternative implementations, the application (707) can be external to the computer (702).

There may be any number of computers (702) associated with, or external to, a computer system containing computer (702), wherein each computer (702) communicates over network. Further, the term “client,” “user,” and other appropriate terminology may be used interchangeably as appropriate without departing from the scope of this disclosure. Moreover, this disclosure contemplates that many users may use one computer (702), or that one user may use multiple computers (702).

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed:

1. A method for enhancing visual inspection of a completed voting ballot, the method comprising:
receiving, by a central processing unit (CPU), the completed voting ballot, wherein the completed voting ballot comprises one or more races, and wherein the completed voting ballot is an unsubmitted ballot that has not been finally submitted;
displaying, by the CPU, the completed voting ballot on a display to a ballot checker;
overlaying, by the CPU, a scan path over the completed voting ballot, wherein the scan path is determined by an optimal search strategy;
scanning, by the CPU, each of the one or more races on the completed voting ballot using the scan path, wherein one or more ballot error indicators of the optimal search strategy identifies at least one ballot error on the completed voting ballot; and
signaling, by the CPU, the at least one ballot error on the display.

2. The method of claim 1, wherein scanning each of the one or more races further comprises:
utilizing, by the CPU, a scanning guidance interface to visually present the scan path to the ballot checker on the display, wherein the scanning guidance interface comprises a scan path indicator configured to indicate to the ballot checker which of the one or more races is being scanned,
wherein the scan path indicator is represented by one or more characteristics comprising color, shape, size, and opacity.

3. The method of claim 2, wherein signaling the at least one ballot error is accomplished by changing the one or more characteristics of the scan path indicator.

4. The method of claim 1, further comprising:
revising the completed voting ballot using at least one ballot correction corresponding to the at least one ballot error.

5. The method of claim 1, wherein receiving the completed voting ballot further comprises:
capturing an image of a physical completed voting ballot via an imaging device operably coupled to the CPU; and
storing the image as the completed voting ballot to a storage medium operably coupled to the CPU.

6. The method of claim 5, wherein revising the completed voting ballot further comprises:
physically revising, by the ballot checker, the at least one ballot correction corresponding to the at least one ballot error on the physical completed voting ballot; and
submitting, by the ballot checker, the revised physical completed voting ballot.

7. The method of claim 1, wherein revising the completed voting ballot further comprises:
receiving, by a voting device, input from the ballot checker, wherein the input is received through an input device, and wherein the input comprises at least one ballot correction corresponding to the at least one ballot error;
revising, by the voting device, the completed voting ballot using the input from the ballot checker; and
submitting, by the voting device, the revised completed voting ballot.

8. The method of claim 7, wherein the voting device is a direct recording electronic (DRE) system or a ballot-marking device (BMD).

9. The method of claim 7, wherein the voting device comprises the CPU.

10. The method of claim 1, wherein the CPU utilizes eye-tracking technology configured to track a sight line of the ballot checker.

11. A system for enhancing a visual inspection of a completed voting ballot, the system comprising:
the completed voting ballot;
a ballot checker; and
a ballot checking device comprising:
a display;
one or more processors; and
a non-transitory computer-readable medium comprising computer-executable instructions stored thereon that, when executed on the one or more processors, cause the one or more processors to perform a method comprising:
receiving the completed voting ballot, wherein the completed voting ballot comprises one or more races, and wherein the completed voting ballot is an unsubmitted ballot that has not been finally submitted;
displaying the completed voting ballot on the display to the ballot checker;
overlaying a scan path over the completed voting ballot, wherein the scan path is determined by an optimal search strategy;
scanning each of the one or more races on the completed voting ballot using the scan path, wherein the scanning identifies at least one ballot error; and
signaling the at least one ballot error on the display.

12. The system of claim 11, wherein scanning each of the one or more races by the one or more processors of the ballot checking device further comprises:
utilizing a scanning guidance interface to visually present the scan path to the ballot checker on the display, wherein the scanning guidance interface comprises a scan path indicator configured to indicate to the ballot checker which of the one or more races is being scanned,
wherein the scan path indicator is represented by one or more characteristics comprising color, shape, size, and opacity.

13. The system of claim 12, wherein signaling the at least one ballot error is accomplished by changing the one or more characteristics of the scan path indicator.

14. The system of claim 11, wherein the at least one ballot error is identified using one or more ballot error indicators of the optimal search strategy.

15. The system of claim 11, wherein the system further comprises:
a physical completed voting ballot;
wherein the ballot checking device further comprises:
an imaging device;
wherein receiving the completed voting ballot by the one or more processors of the ballot checking device further comprises:
capturing an image of the physical completed voting ballot via the imaging device; and
storing the image as the completed voting ballot to the non-transitory computer-readable medium of the ballot checking device.

16. The system of claim 15, wherein signaling the at least one ballot error causes the ballot checker to physically mark at least one ballot correction corresponding to the at least one ballot error on the physical completed voting ballot.

17. The system of claim 11, further comprising:
a voting device comprising:
the completed voting ballot; and
an input device configured to:
receive input from the ballot checker, wherein the input comprises at least one ballot correction corresponding to the at least one ballot error;
wherein the voting device is configured to revise the completed voting ballot using the input from the ballot checker.

18. The system of claim 17, wherein the voting device is a direct recording electronic (DRE) system or a ballot-marking device (BMD).

19. The system of claim 17, wherein the voting device comprises the ballot checking device.

20. The system of claim 11, wherein the ballot checking device further comprises:
an eye-tracking device configured to track a sight line of the ballot checker.
